(19) United States
(12) Patent Application Publication
(10) Pub. No.: US 2006/0066073 A1
(43) Pub. Date: Mar. 30, 2006

(54) Pedal drive

(76) Inventor: Charles Schuft, Boxborough, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/229,026

(22) Filed: Sep. 16, 2005

Related U.S. Application Data
(60) Provisional application No. 60/611,039, filed on Sep. 17, 2004.

(51) Int. Cl. B62M 1/02

(52) U.S. Cl. 280/259

(57) ABSTRACT

A pedal drive which includes a drive sprocket that is rotatable about a drive axis. A pedal system is provided and has at least one pedal. The pedal system can be rotatable about the drive axis for rotatably driving the drive sprocket with rotation of the at least one pedal about the drive axis. The drive sprocket can also be capable of rotating relative to the pedal system in one direction. The pedal system is capable of allowing movement of the at least one pedal radially inward and outward relative to the drive axis. An auxiliary transmission system can be coupled between the pedal system and the drive sprocket for further rotatably driving the drive sprocket with the at least one of the radially inward and outward movement of the at least one pedal. A clutch system can be coupled between the pedal system and the drive sprocket for allowing the auxiliary transmission system to rotatably drive the drive sprocket with the at least one of the radially inward and outward movement of the at least one pedal.

### RELATED APPLICATION

This application claims the benefit of U.S. Provisional Application No. 60/611,039, filed Sep. 17, 2004. The entire teachings of the above application are incorporated herein by reference.

### BACKGROUND

The pedal system on a bicycle 10 such as seen in FIG. 1 commonly includes pedals 12 that are attached to a drive sprocket 18 by crank arms 16 for driving the rear wheel 14 with a chain 20. The crank arms 16 are located on opposite sides of the bicycle 10 and are positioned 180° relative to each other. As a result, as shown in FIG. 2, one pedal 12 can be at the top dead center position, and the other pedal 12 can be at the bottom dead center position, twice in a single revolution of the drive sprocket 18. Since the force F exerted on the pedals by the rider of the bicycle 10 is mostly in the downward direction, these top and bottom dead center positions are generally considered “dead” zones where little tangential driving force is transferred to the pedal system.

### SUMMARY

The present invention can provide a pedal drive that can generate additional driving force when the pedals are in a dead zone. The pedal drive can include a drive sprocket that is rotatable about a drive axis. The pedal system can be included and have at least one pedal. The pedal system can be rotatable about the drive axis for rotatably driving the drive sprocket with rotation of the at least one pedal about the drive axis. The drive sprocket can also be capable of rotating relative to the pedal system in one direction. The pedal system is capable of allowing movement of the at least one pedal radially inward and outward relative to the drive axis. An auxiliary transmission system can be coupled between the pedal system and the drive sprocket for further rotatably driving the drive sprocket with the at least one of the radially inward and outward movement of the at least one pedal. A clutch system can be coupled between the pedal system and the drive sprocket for allowing the auxiliary transmission system to rotatably drive the drive sprocket with the at least one of the radially inward and outward movement of the at least one pedal.

In particular embodiments, the auxiliary transmission system can rotatably drive the drive sprocket ahead of the rotation provided by the rotation of the at least one pedal about the drive axis. The pedal system can be coupled to a drive axis shaft. The pedal system can include first and second pedal assemblies having respective first and second pedals. The first and second pedal assemblies can be coupled together along the drive axis by the drive axis shaft. Each pedal assembly can include a pivoting linkage which allows the radially inward and outward movement of the pedal. The drive sprocket can be positioned concentrically about the drive axis shaft. The auxiliary transmission system can include first and second auxiliary transmission assemblies coupled between respective first and second pedal assemblies and the drive sprocket. Each auxiliary transmission assembly can include a pinion assembly and a transmission wheel. The transmission wheel and the drive sprocket can be configured to rotate in unison about the drive axis. The pinion assembly can be rotatable by one of the radially inward and outward movement of respective pedal. Rotation of the pinion assembly can drive the transmission wheel on the drive sprocket. The clutch system can include first and second clutch assemblies coupled to respective first and second transmission assemblies. In another embodiment, the auxiliary transmission system can include first and second offset wheels rotatably positioned on a parallel axis to the drive axis. The first offset wheel can engage a first transmission wheel rotatably fixed to the drive sprocket. The second offset wheel can engage a second transmission wheel which is rotatably independent from the drive sprocket about the drive axis. The pedal drive can be on a bicycle for rotatably driving a bicycle wheel with a chain engaged with the drive sprocket and a rear sprocket on the bicycle wheel.

The present invention can also provide a rotational drive including a drive wheel rotatable about a drive axis. A crank system can be included and have at least one crank end. The crank system can be rotatable about the drive axis for rotatably driving the drive wheel with rotation of the at least one crank member about the drive axis. The drive wheel can also be capable of rotating relative to the crank system in one direction. The crank system can be capable of allowing movement of the at least one crank end radially inward and outward relative to the drive axis. An auxiliary transmission system can be coupled between the crank system and the drive wheel for further rotatably driving the drive wheel with at least one of the radially inward and outward movement of the at least one crank end. A clutch system can be coupled between the crank system and the drive wheel for allowing the auxiliary transmission system to rotatably drive the drive wheel with the at least one of the radially inward and outward movement of the at least one crank end.

The present invention can additionally provide a method of rotatably driving a drive sprocket about a drive axis including providing a pedal system having at least one pedal. A drive sprocket can be rotatably driven about a drive axis with rotation of the at least one pedal about the drive axis. The drive sprocket can also be capable of rotating relative to the pedal system in one direction. The at least one pedal can move radially inward and outward relative to the drive axis. The drive sprocket can be further rotatably driven with the at least one radially inward and outward movement of the at least one pedal with an auxiliary transmission system coupled between the pedal system and the drive sprocket. A clutch system can be coupled between the pedal system and the drive sprocket to allow the auxiliary transmission system to rotatably drive the drive sprocket with at least one of the radially inward and outward movement of the at least one pedal.

The present invention can further provide a method of rotatably driving a drive wheel about a drive axis including providing a crank system having at least one crank end. The drive wheel can be rotatably driven with rotation of the at least one crank end about the drive axis. The drive wheel can also be capable of rotating relative to the crank system in one direction. The at least one crank end can move radially inward and outward relative to the drive axis. The drive wheel can be further rotatably driven with at least one of the radially inwardly and outwardly movement of the at least one crank end with an auxiliary transmission system coupled between the crank system and the drive wheel. A clutch system can be coupled between the pedal system and the drive wheel allowing the auxiliary transmission system to rotatably drive the drive wheel with at least one of the radially inward and outward movement of the at least one crank end.

### BRIEF DESCRIPTION OF THE DRAWINGS

The foregoing and other objects, features and advantages of the invention will be apparent from the following more particular description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a side view of a prior art bicycle.

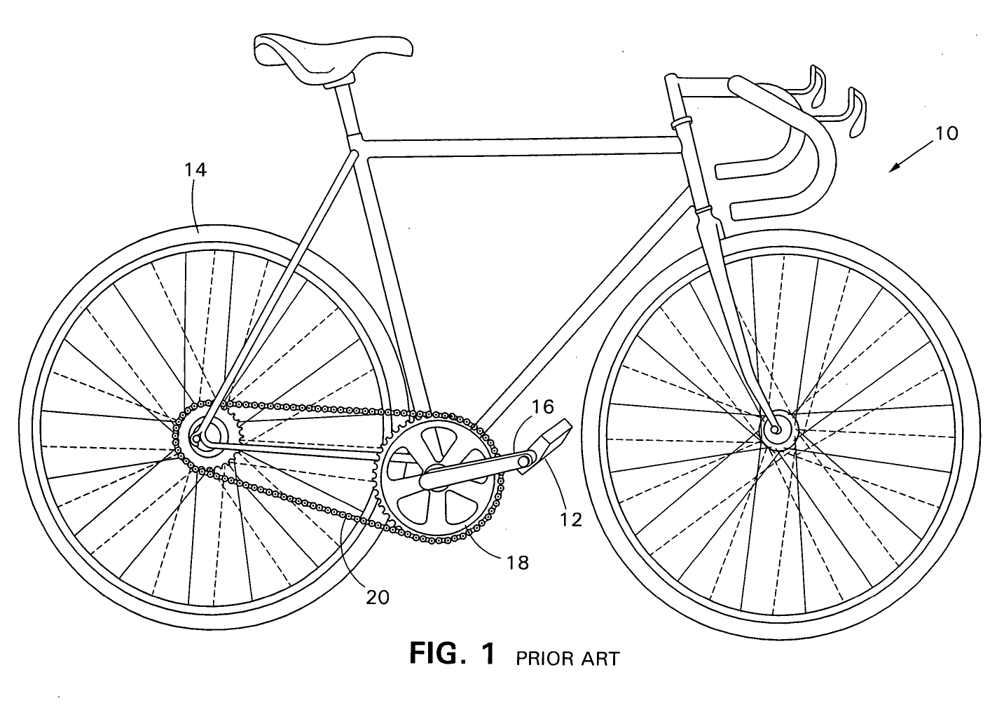

FIG. 2 is a schematic side view of a prior art pedal drive with the pedals positioned in top and bottom dead center positions.

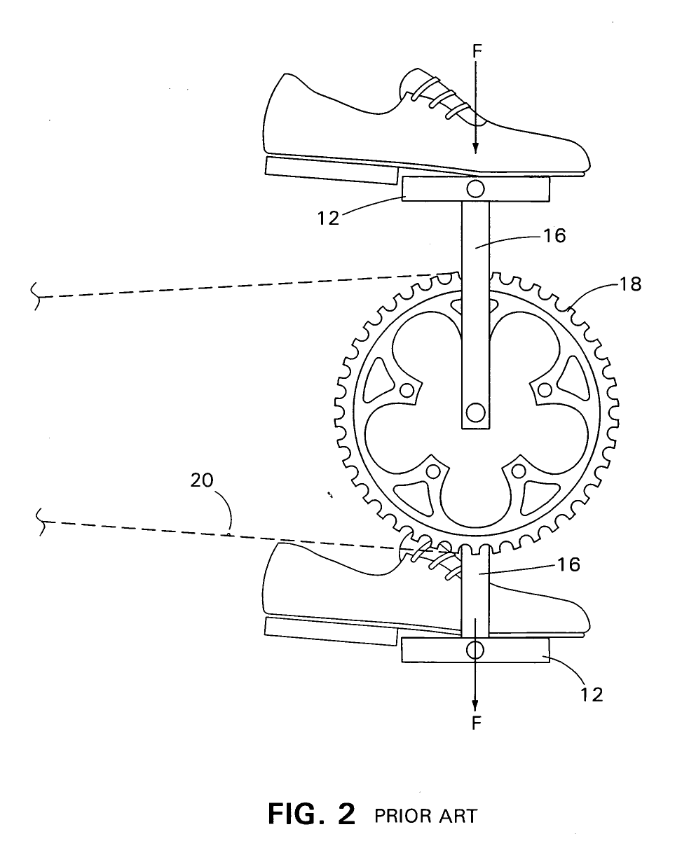

FIG. 3 is a perspective exploded view of an embodiment of a bicycle frame to which a pedal drive in the present invention can be mounted.

FIG. 4 is a perspective view of an embodiment of a pedal drive in the present invention with portions on one side omitted for clarity.

FIG. 5 is a perspective view of an embodiment of a sprocket assembly.

FIG. 6 is a side schematic view of one side of a front portion of the pedal drive of FIG. 4.

FIG. 7 is a front schematic view of the portion of the pedal drive of FIG. 6.

FIG. 8 is a perspective schematic exploded view of another embodiment of a front portion of a pedal drive.

FIG. 9 is a perspective schematic exploded view of still another embodiment of a front portion of a pedal drive.

FIG. 10 is a side schematic view of one side of yet another embodiment of a front portion of a pedal drive.

FIG. 11 is a side schematic view of one side of another embodiment of a front portion of a pedal drive.

FIGS. 12 and 13 are side schematic views of further embodiments for converting slider motion to drive sprocket motion.

FIG. 14 is a perspective schematic view of an embodiment using parallel axes.

### DETAILED DESCRIPTION

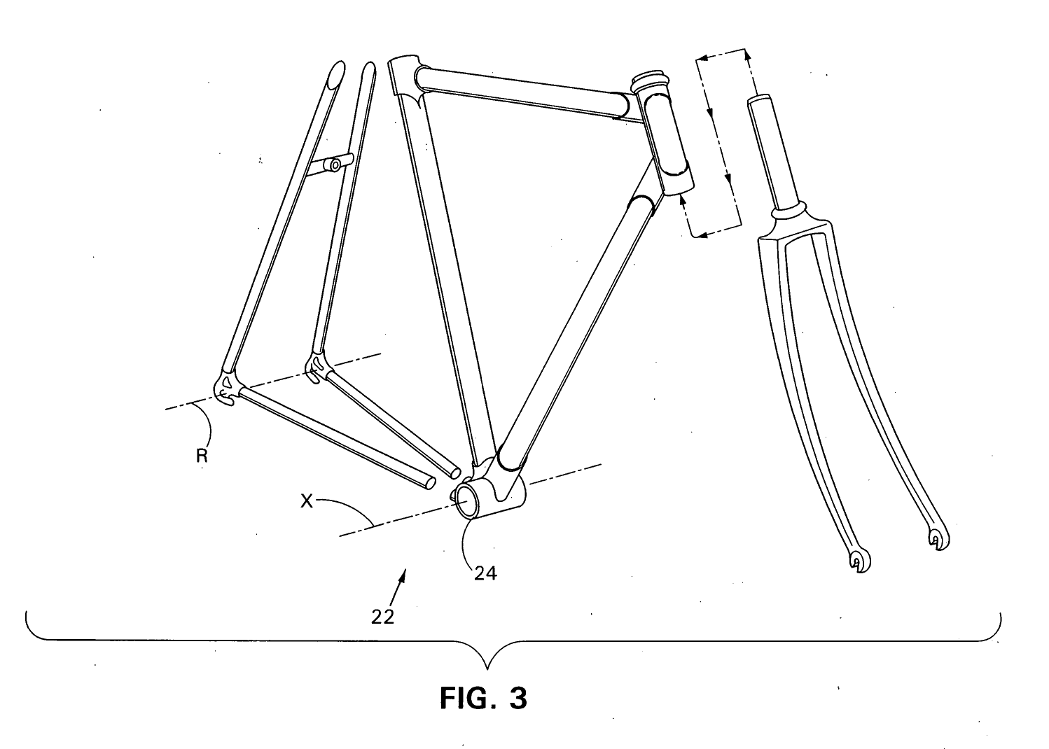

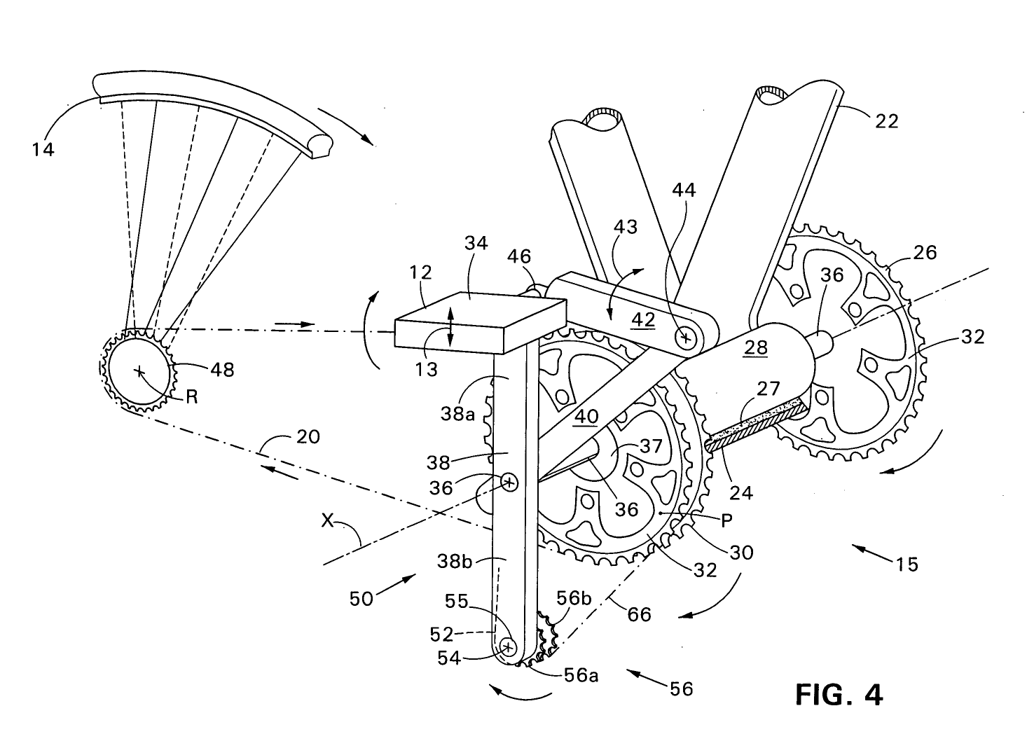

Referring to FIGS. 3 and 4, an embodiment of a pedal drive 15 can be mounted to a bicycle frame 22 when used on a bicycle. The pedal drive 15 can include a pedal system having two pedal assemblies 34 rotatably mounted about or along a front drive axis X. The second pedal assembly 34 is omitted in FIG. 4 for clarity. The drive axis X can extend through a cylindrical bottom bracket shell 24 of the frame 22. The rotation of pedals 12 at the crank ends of the pedal assemblies 34 can drive a front drive sprocket or wheel 30 to drive a rear or driven sprocket 48 and a bicycle wheel 14 with a chain 20. The rear sprocket 48 can be rotatably mounted to the frame 22 along a rear axis R. Rotation of the rear sprocket 48 can drive the wheel 14 of the bicycle. The pedal assemblies 34 can allow the pedals 12 to move radially inwardly and outwardly relative to drive axis X, for example, at the top and bottom dead center positions. An auxiliary transmission system having two auxiliary transmission assemblies 50 can be included in the pedal drive 15 for further rotatably driving the drive sprocket 30 with the radially inwardly and/or outwardly movement of the pedals 12, in addition to being driven by the rotation of the pedals 12. This radially inwardly and outwardly movement of the pedals 12 can occur at the top and bottom dead center positions and provide additional driving of the wheel 14 over that provided solely by rotation of the pedals 12 about the drive axis X.

A more detailed description now follows. The pedal assemblies 34 can be on opposite sides of the frame 22 and can be rigidly connected or fixed to each other by a drive axis shaft 36 which passes through the bottom bracket shell 24 of the frame 22. Typically, the pedals 12 are positioned 180° apart from each other so that when one pedal 12 is at the top dead center position, the other pedal 12 will be at the bottom dead center position. Each pedal assembly 34 can include a crank arm member 40 that is fixed to the drive axis shaft 36. A pivoting crank arm member 42 can be pivotably or rotatably connected to crank arm member 40 at a rotational joint or pivot 44. The pedal 12 can be rotatably connected to a rotational joint or pivot 46 at or near the distal end of the pivoting crank arm member 42. The pivoting crank arm member 42 can rotate slightly as shown by the arrows 43 to allow radially inward and outward movement of the pedal 12 relative to the drive axis X, as shown by arrows 13. The movement of the pedal 12 can be in a slight arc.

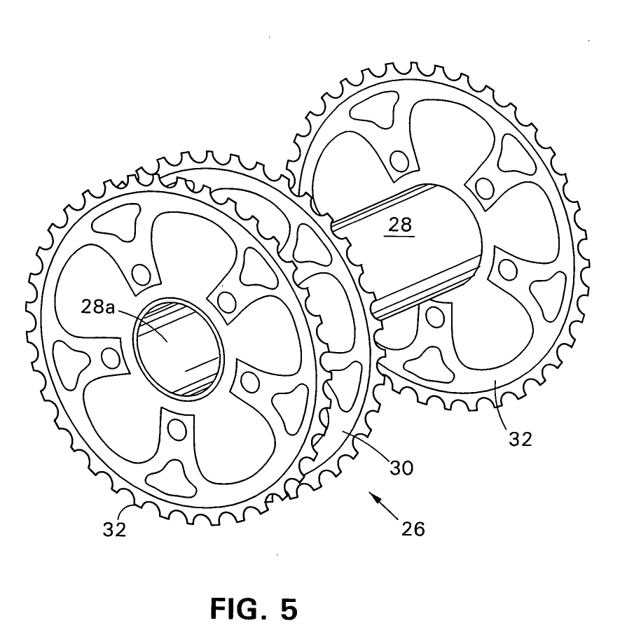

The drive axis shaft 36 can be supported along the drive axis X within the bottom bracket shell 24 by an inner bearing arrangement 37, a drive wheel or sprocket assembly 26 and an outer bearing arrangement 27. The sprocket assembly 26 can include a tube axle 28, to which the drive sprocket 30 is fixed (FIG. 5). Auxiliary transmission wheels or sprockets 32 of the auxiliary transmission assemblies 50 can be fixed to the tube axle 28 at or near opposite ends. The tube axle 28 of the sprocket assembly 26 can be rotatably mounted about the drive axis shaft 36 by the inner bearing arrangement 37 positioned within the interior 28a of the tube axle 28. The tube axle 28 also can be rotatably mounted within the bottom shell bracket 24 by the outer bearing arrangement 27. The bearing arrangements 37 and 27 can each include one or more roller bearings, ball bearings, tapered bearings, bushings, etc. As a result, the drive axis shaft 36 and the tube axle 28 of the sprocket assembly 26 are concentrically mounted relative to each other, and can be rotatable relative to each other as well as the bottom bracket shell 24. This can allow rotation of the pedal assemblies 34 about the drive axis X and can allow independent rotation of the drive sprocket 30 and sprocket assembly 26 relative to the pedal assemblies 34.

The drive sprocket 30 is shown as a single sprocket but it is understood that drive sprocket 30 can also include one or more drive sprockets of different sizes to allow the changing of gear ratios. The diameter of the auxiliary transmission sprockets 32 can be about the same diameter as the drive sprocket 30 as shown, but can be varied depending upon the situation at hand.

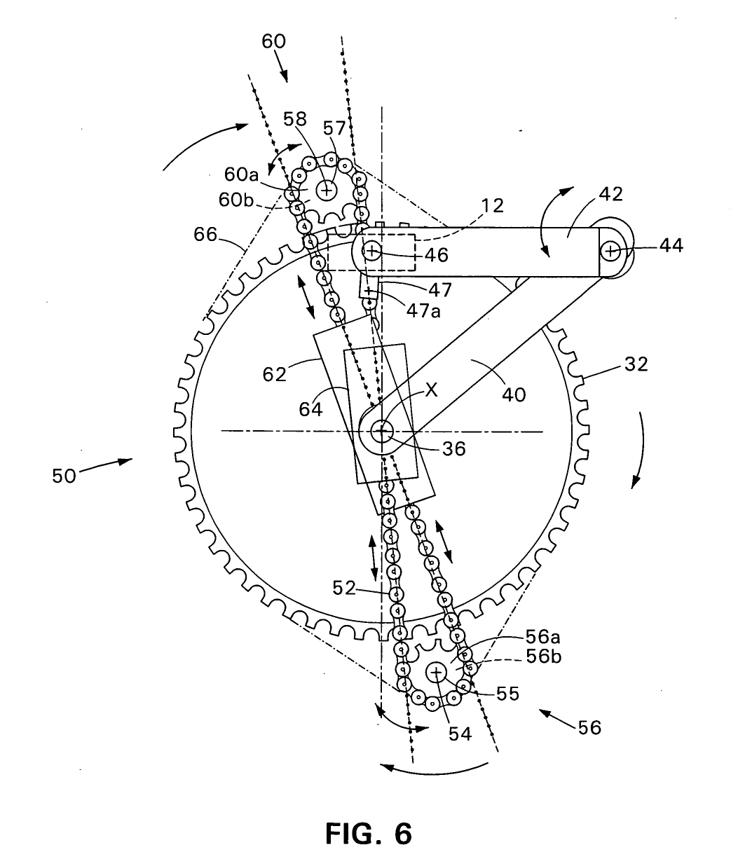

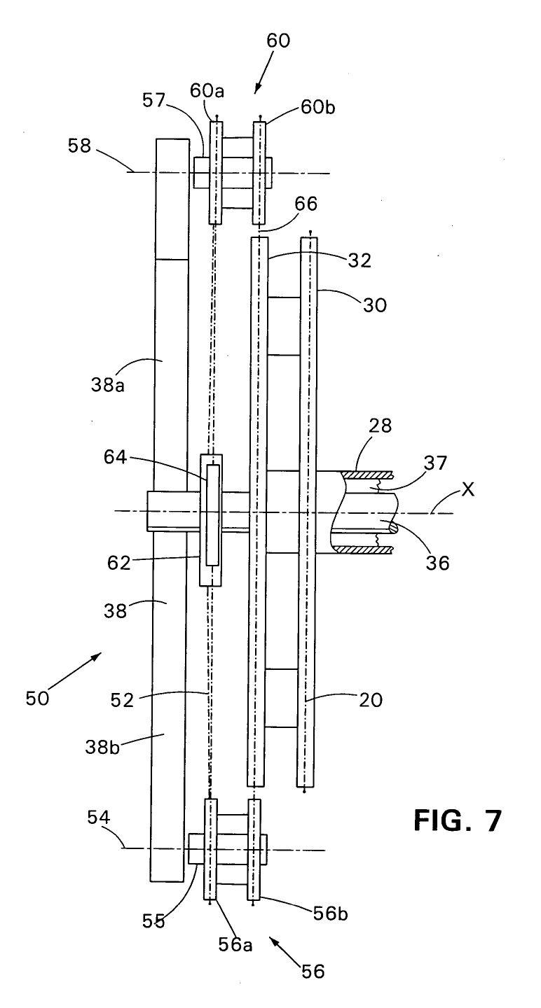

In each auxiliary transmission assembly 50, a crank leg member 38 can be fixed to the drive axis shaft 36 on opposite ends, at an angle relative to the crank arm member 40 of the pedal assembly 34, for example about 45°. The crank leg member 38 can have first 38a and second 38b portions extending in opposite directions radially outward from the drive axis X. Referring to FIGS. 6 and 7, in each auxiliary transmission assembly 50, first 60 and second 56 pinion assemblies can be rotatably coupled to respective opposing portions 38a and 38b of the crank leg member 38 about respective axes 58 and 54. The first 60 and second 56 pinion assemblies can be positioned beyond the outer diameter of the auxiliary transmission sprocket 32. The pinion assemblies 60 and 56 can have respective first or outer pinion wheels or sprockets 60a/56a and second or inner pinion wheels or sprockets 60b/56b. The outer pinion sprockets 60a and 56a can be positioned in alignment with each other (FIG. 7), and the inner pinion sprockets 60b and 56b can be positioned in alignment with each other and an associated auxiliary transmission sprocket 32.

A first auxiliary transmission cable or chain 52 can engage the outer pinion sprockets 60a and 56a in a figure eight configuration (FIGS. 6 and 7). The pedal 12 can be coupled to the first auxiliary transmission chain 52 with a pivoting link 47 between pivoting joints 47a and 46. The radially inward and outward movement of pedal 12 by the pivoting of crank arm member 42 can be transferred to the chain 52 by the link 47 to move the chain 52 in a reciprocating manner. Pivoting of link 47 can compensate for an arched path of the pedal 12 as the pedal 12 pivots on the pivoting crank arm member 42.

Referring to FIG. 6, the chain 52 can include first 62 and second 64 clearance rings or members which encircle around the drive axis shaft 36 so that the chain 52 does not chafe against the drive axis shaft 36. The first 62 and second 64 clearance rings can be of different sizes as shown to allow the chain 52 to be arranged or twisted in the figure eight configuration between sprockets 60a and 56a. The clearance rings 62 and 64 can be configured to allow the direction of the tension forces of the chain 52 to pass through the center of the drive axis shaft 36 in a straight line to maximize the transfer of power from the pedal 12 to the outer pinion sprockets 60a and 56a. Alternatively, the clearance rings 62 and 64 can be replaced with pulleys.

In each auxiliary transmission assembly 50, a second auxiliary transmission chain 66 can engage the inner pinion sprockets 60b/56b and the associated auxiliary transmission sprocket 32, as seen in FIGS. 6 and 7. A clutch system is included having a clutch assembly associated with each auxiliary transmission assembly 50. The pinion assemblies 60 and 56 can include respective first and second clutch arrangements 57 and 55, which make up a clutch assembly. The first clutch arrangement 57 can allow forward (shown in FIG. 6 to be clockwise) rotation and driving of both pinion sprockets 60a/60b of the first pinion assembly 60 when the pedal 12 is moved radially inwardly to drive the chain 52. At the same time, the second clutch arrangement 55 can allow one or both pinion sprockets 56a/56b of the second pinion assembly 56 to rotate freely. When the pedal 12 is moved radially outwardly to drive the chain 52 in the opposite direction, the first clutch arrangement 57 allows one or both pinion sprockets 60/a/60b of the first pinion assembly 60 to free wheel. At the same time, the second clutch arrangement 55 allows the pinion sprockets 56a/56b of the second pinion assembly 56 to be driven by the chain 52 in the forward rotational direction (shown in FIG. 6 to be clockwise). The clutch arrangements 57 and 55 can each include one or more clutches. The clutches can lock in one rotational direction and allow rotational movement in the opposite direction, and, for example, can be a roller clutch. Alternatively, the clutches can be electronically operated, for example, a particle brake, and can be actuated by switches, sensors and/or a processor.

Therefore, when the pedals 12 and pedal assemblies 34 are rotationally driven about the drive axis X by a rider, the drive axis shaft 36 freely rotates within bearing arrangement 37. Since each pedal assembly 34 is connected to a crank leg member 38, each crank leg member 38 is also rotatable about driven the drive axis X. The rotation of a crank leg member 38 about the drive axis X is transferred to and rotates the associated auxiliary transmission sprocket 32 because the inner pinion sprockets 60b/56b on the crank leg member 38 are connected to the transmission sprocket 32 by the second auxiliary transmission chain 66. Consequently, on one side of a bicycle, the pedal assembly 34, drive axis shaft 36, the crank leg member 38, the pinion assemblies 60/56, the clutch arrangements 57/55 and auxiliary transmission chains 52/66 can all rotate about the drive axis X for driving the associated auxiliary transmission sprocket 32. Since the auxiliary transmission sprockets 32 and the drive sprocket 30 are fixed to each other by the tube axle 28, the drive sprocket 30 can be rotationally driven for driving the bicycle wheel 14.

Further rotational driving of the auxiliary transmission sprockets 32 and the drive sprocket 30 can be provided by the radially inwardly and outwardly movement of the pedals 12 which reciprocate the first auxiliary transmission chains 52. When a rider forces a pedal 12 to move inwardly, the moving chain 52 causes rotation of the pinion sprockets 60a/60b forwardly, and the inner pinion sprocket 60b drives the associated second transmission chain 66 forwardly (shown in FIG. 6 to be clockwise). Since the sprocket assembly 26 can rotate independently from the drive axis shaft 36, the second auxiliary transmission chain 66 drives the associated auxiliary transmission sprocket 32 forwardly in addition to or independently from that provided by the rotation of the pedals 12. For example, referring to FIG. 4, the position P on the auxiliary transmission sprocket 32 will rotate forwardly toward the portion 38b of crank leg member 38. During radially outward movement of pedal 12, the pinion sprockets 56a/56b are driven forwardly by the first auxiliary transmission chain 52 which provides forward movement of the second auxiliary transmission chain 66 to drive the associated auxiliary transmission sprocket 32 and drive sprocket 30 further forwardly. The clutch arrangements 57 and 55 allow free wheeling of one or more of the pinion sprockets in the backward direction so that the additional driving of the drive sprocket 30 in the forward direction can be obtained on both radially inward and outward movement of the pedals 12. The clutch arrangements 57/55 can allow independent forward movement of the drive sprocket 30 relative to the pedal assemblies 34 and the drive axis shaft 36 but not backward movement.

The radially inward movement of a pedal 12 can occur when the pedal 12 is at or near the top dead center position and a majority of the radially outward movement of the pedal 12 can occur when the pedal 12 is at or near the bottom dead center position. Some radially inwardly and outwardly movement of the pedal 12 can occur at other positions. With such possible radially inwardly and outwardly movement of pedal 12, the pedal 12 can travel through a shorter path than if no radial movement were possible.

Depending upon the sizes of the sprockets chosen, in one embodiment, the inward movement of a pedal 12 near or at the top dead center position can add 30° of rotation, and the radially outward movement of the pedal 12 near or at the bottom dead center position can add another 30° of rotation to the drive sprocket 30, in addition to that already provided by the rotation of the pedals 12 about the drive axis X. In this manner, the dead zones can be used to provide driving and further rotation of the drive sprocket 30, instead of providing little or no driving as in the prior art.

In some embodiments, the pedal 12 can move inwardly and outwardly about 2 inches. The pinion sprockets 60a, 60b, 56a, and 56b can have 11 teeth with a 2.375 inch diameter, and the drive sprocket 30 and the auxiliary transmission sprockets 32 can have a diameter of 8.5 inches. The auxiliary transmission sprockets 32 can be the same size as the drive sprocket 30 to provide sufficient torque from the radially inwardly and outwardly movement of the pedal 12. The size of the auxiliary transmission sprockets 32 and/or the pinion sprockets can be varied to suit the application at hand.

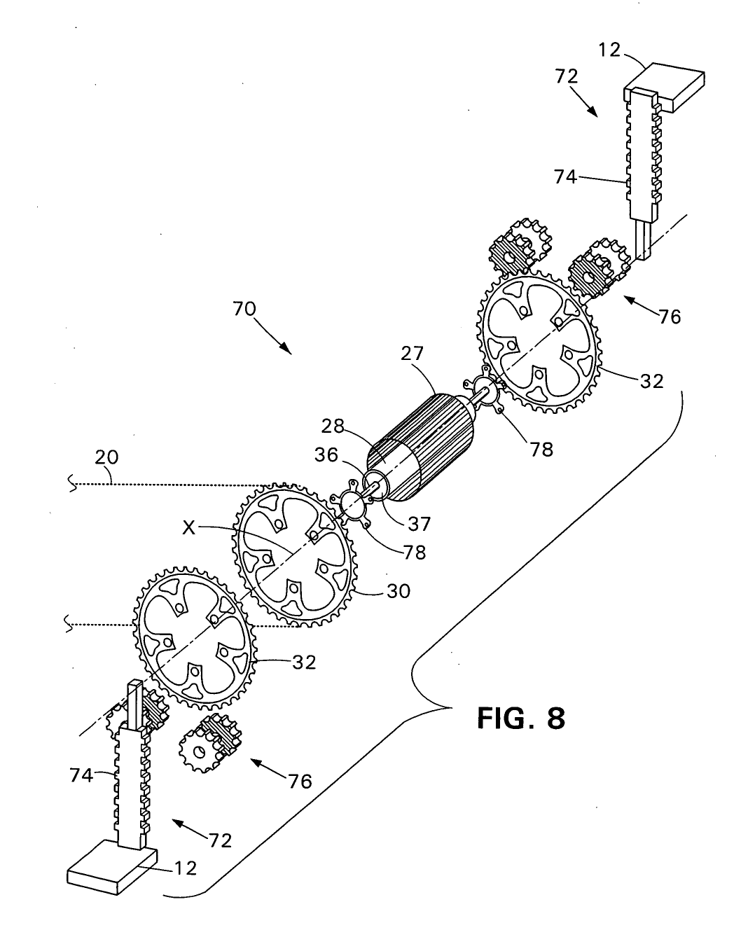

Referring to FIG. 8, pedal drive 70 is another embodiment in the present invention which differs from pedal drive 15 in that radially inwardly and outwardly movement or translation of the pedals 12 can be provided by a pedal assembly 76 having a fixed straight chain or gear rack 74, or similar gearing, as known to those in the art, which engages the pinion gears of pinion assemblies 76. The pinion assemblies 76 can be provided with clutch assemblies for providing additional driving of the auxiliary transmission sprockets 32 and drive sprocket 30, with radially inward and outward movement of the pedals 12. Brackets 78 can be used to hold the sprockets 30 and 32 in position relative to tube axle 28.

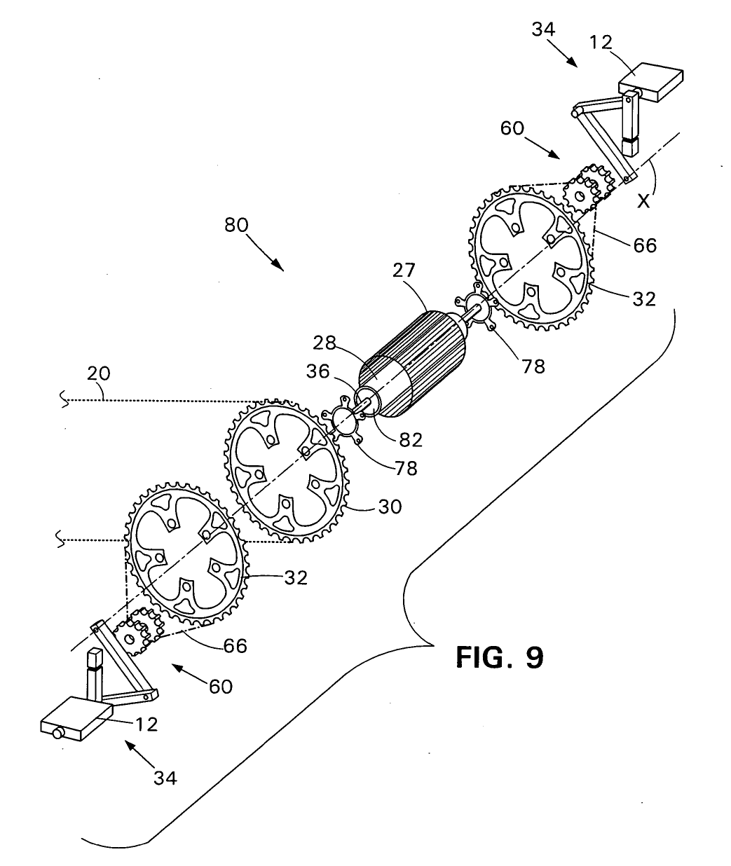

Referring to FIG. 9, pedal drive 80 is still another embodiment in the present invention which differs from pedal drive 15 in that an advancable rotational coupling or clutch assembly 82 such as a roller clutch can be positioned between the drive axis shaft 36 and the tube axle 28. Consequently, forward rotation of the drive axis shaft 36 by rotation of the pedals 12 about the drive axis X can drive the sprocket assembly 26 and the drive sprocket 30. The clutch assembly 82 can also allow the auxiliary transmission sprockets 32 to further drive the drive sprocket 30 in advance of that provided by the rotation of the pedals 12. Pinion assemblies 60 can be employed for providing additional driving with either inwardly or outwardly radial movement of pedal 12. For example, additional driving may only be desired during inward movement of pedal 12, or alternatively, during outward movement of pedal 12.

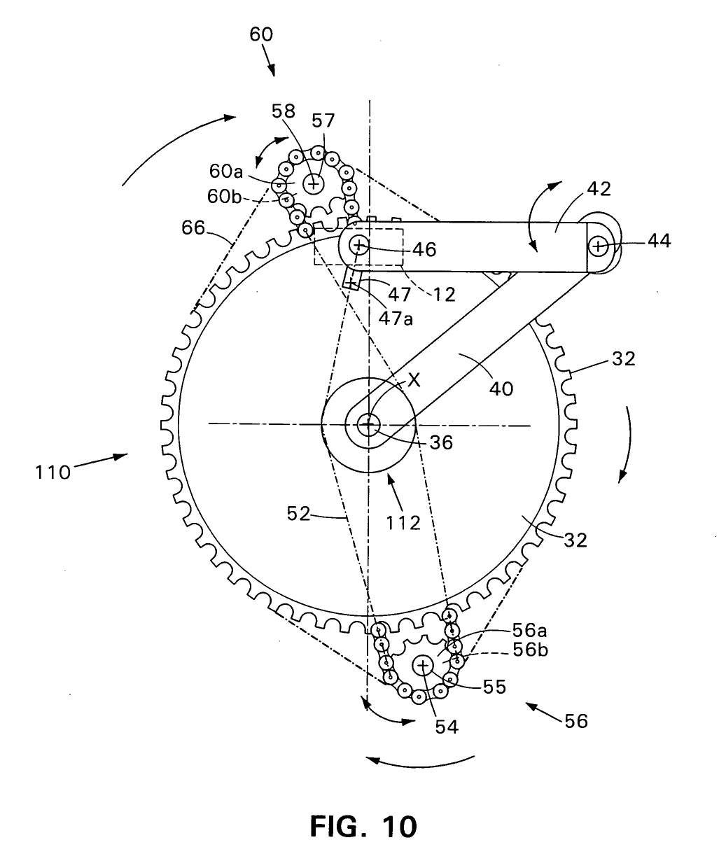

Referring to FIG. 10, pedal drive 110 is yet another embodiment in the present invention which differs from pedal drive 15 in that a pulley arrangement 112 can be used to allow the auxiliary transmission chain 52 to pass by the drive axis shaft 36.

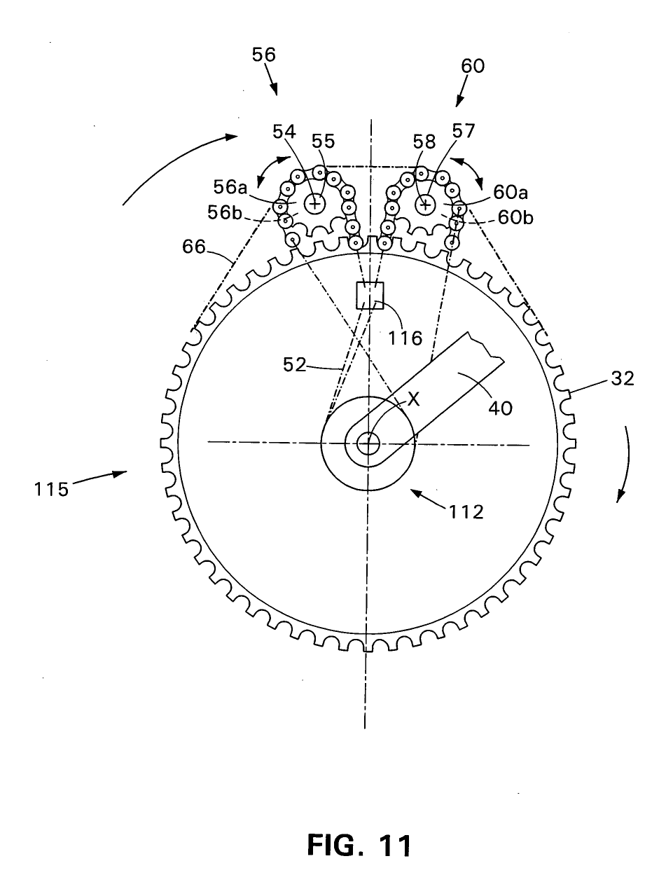

Referring to FIG. 11, pedal drive 115 is another embodiment in the present invention which differs from pedal drive 110 in that the first 60 and second 56 pinion assemblies are located near each other instead of on opposite sides of the auxiliary transmission sprocket 32. The first auxiliary transmission chain 52 can be coupled to a connecting member 116 between the positions of the pinion assemblies 60 and 56.

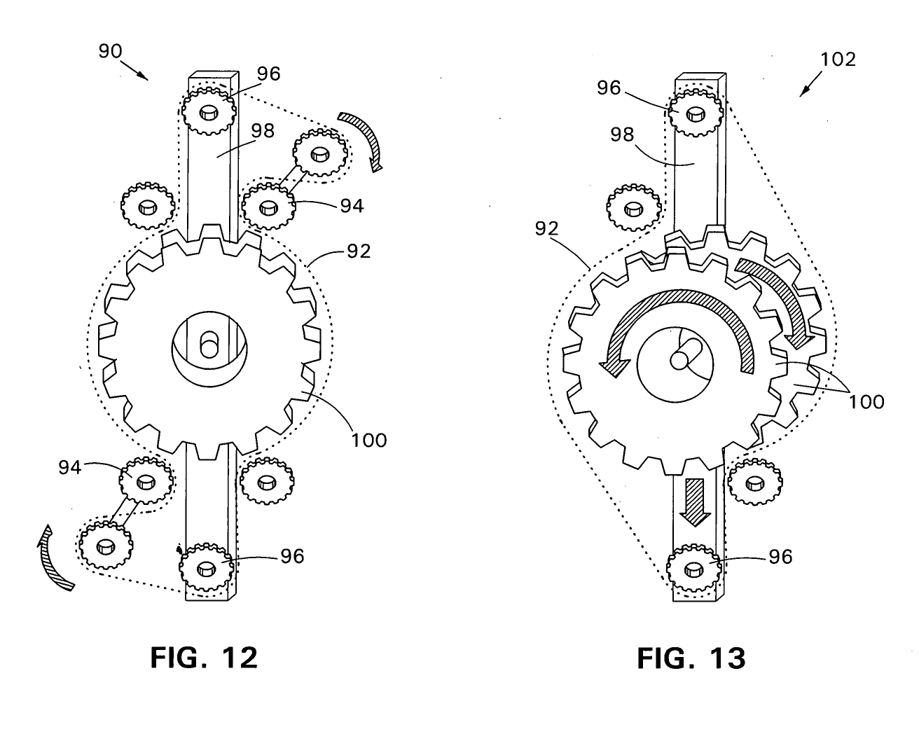

FIG. 12 depicts another possible mechanism 90 in which a pedal slider 98 draws down a chain 92 connected to a sprocket 100 fixed to the tube axle 28. Spring loaded sprockets 94 can provide tension and slack for the chain 97 and racheting gears 96.

FIG. 13 depicts a mechanism 102 having two parallel sprockets 100 in close proximity which can be racheted to drive the tube axle 28 forward, and free wheel backward.

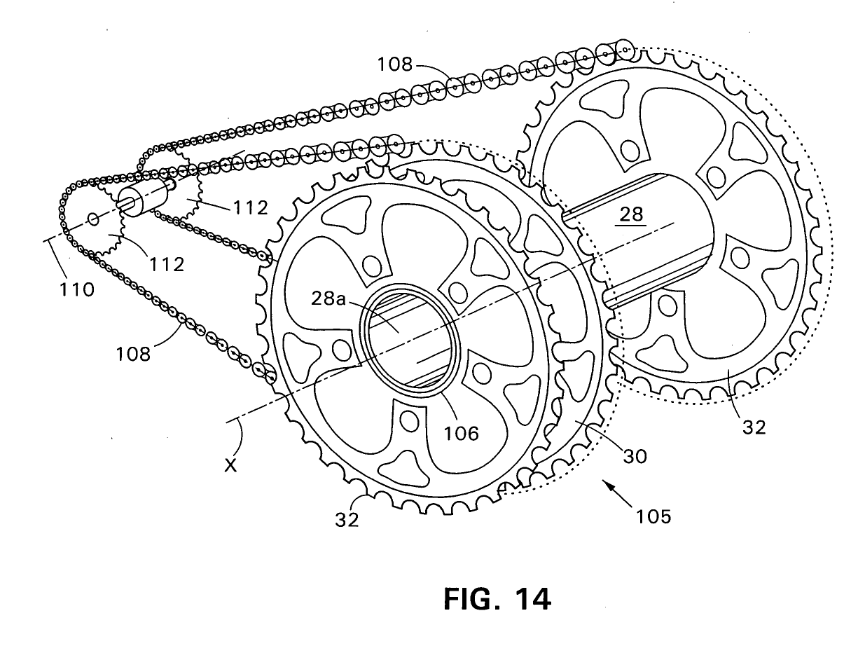

FIG. 14 depicts a sprocket assembly 105 which differs from sprocket assembly 26 in that one auxiliary transmission sprocket 32, for example, the one adjacent to the drive sprocket 30, can be rotatably mounted to a bearing arrangement 106 to allow rotation relative to the other auxiliary transmission sprocket 32 and the drive sprocket 30. Alternatively, the other auxiliary transmission sprocket 32 can be rotatable instead. Two sprockets or wheels 112 can be rotatably mounted about a parallel axis 110 and connected to respective auxiliary transmission sprockets 32 by chains 108. The sprockets 112 can be connected to rotate in unison.

While this invention has been particularly shown and described with references to particular embodiments thereof, it will be understood by those skilled in the art that various changes in form and details may be made therein without departing from the scope of the invention encompassed by the appended claims.

For example, although some of the pedal drives have been described to employ sprockets and chains for power transmission, it is understood that the sprockets can also be replaced with gears, pulleys, drums, wheels, etc., and the chains can be replaced with belts, cables, racks, etc. The inward and outward movement of the pedals 12 can be accomplished by a number of different mechanisms, for example, other linkages such as a scissor type linkage, a telescoping member, a Cardan gear set, a slider mechanism, etc. The pedal drives can be retro fitted into current existing bicycle frames. The tube axle 28 can be replaced with a parallel axle outside the bottom bracket shell 24 with the auxiliary transmission sprockets 32 mounted thereto and connected to the pedal assemblies and drive sprockets by a suitable method, such as by chains or gears. The pinions can be of different sizes to adjust the inward and outward pedal stroke on the top and bottom dead center positions. Portions of the pedal drives can be covered or shielded for safety. A pedal travel guide may be employed to train the pedal motion to the most desirable path. The pedal drives can be employed in devices other than standard bicycles, for example, recumbent bicycles, paddle boats, human powered aircraft, etc. Mechanisms in the present invention can also be used to capture wind or wave energy. In some applications, only one crank side can be employed, and a handle or a mechanical interlock can be used instead of a pedal. The pedals 12 can move in straight or curved paths inwardly and outwardly. A locking mechanism can be used to lock the pedals 12 at a fixed distance from the drive axis X, or stroke limitations can be employed for adjusting the positions that the pedal 12 can travel. Clutch assemblies can be positioned about the drive axis X as desired. Clutches or advancable couplings can be coupled to one or both auxiliary transmission sprockets 32.

What is claimed is:

1. A pedal drive comprising:
a drive sprocket rotatable about a drive axis;
a pedal system including at least one pedal, the pedal system being rotatable about the drive axis for rotatably driving the drive sprocket with rotation of the at least one pedal about the drive axis, the drive sprocket also being capable of rotating relative to the pedal system in one direction, the pedal system capable of allowing movement of said at least one pedal radially inward and outward relative to the drive axis;
an auxiliary transmission system coupled between the pedal system and the drive sprocket for further rotatably driving the drive sprocket with at least one of the radially inward and outward movement of said at least one pedal; and
a clutch system coupled between the pedal system and the drive sprocket for allowing the auxiliary transmission system to rotatably drive the drive sprocket with the at least one of the radially inward and outward movement of said at least one pedal.

2. The pedal drive of claim 1 in which the auxiliary transmission system rotatably drives the drive sprocket ahead of the rotation provided by the rotation of the at least one pedal about the drive axis.

3. The pedal drive of claim 2 in which the pedal system is coupled to a drive axis shaft.

4. The pedal drive of claim 3 in which the drive sprocket is positioned concentrically about the drive axis shaft.

5. The pedal drive of claim 4 in which the pedal system includes first and second pedal assemblies having respective first and second pedals, the first and second pedal assemblies being coupled together along the drive axis by the drive axis shaft.

6. The pedal drive of claim 5 in which the auxiliary transmission system includes first and second auxiliary transmission assemblies coupled between respective first and second pedal assemblies and the drive sprocket.

7. The pedal drive of claim 6 in which the clutch system includes first and second clutch assemblies coupled to respective first and second transmission assemblies.

8. The pedal drive of claim 7 in which each pedal assembly includes a pivoting linkage which allows the radially inward and outward movement of the pedal.

9. The pedal drive of claim 8 in which each auxiliary transmission assembly includes a pinion assembly and a transmission wheel, the transmission wheel and the drive sprocket being configured to rotate in unison about the drive axis, the pinion assembly being rotatable by one of the radially inward and outward movement of a respective pedal, rotation of the pinion assembly driving the transmission wheel and the drive sprocket.

10. The pedal drive of claim 8 in which the auxiliary transmission system includes first and second offset wheels rotatably positioned on a parallel axis to the drive axis, the first offset wheel for engaging a first transmission wheel rotatably fixed to the drive sprocket, and the second offset wheel for engaging a second transmission wheel which is rotatably independent from the drive sprocket about the drive axis.

11. The pedal drive of claim 1 in which the pedal drive is on a bicycle.

12. A rotational drive comprising:
a drive wheel rotatable about a drive axis;
a crank system including at least one crank end, the crank system being rotatable about the drive axis for rotatably driving the drive wheel with rotation of the at least one crank member about the drive axis, the drive wheel also being capable of rotating relative to the crank system in one direction, the crank system capable of allowing movement of said at least one crank end radially inward and outward relative to the drive axis;
an auxiliary transmission system coupled between the crank system and the drive wheel for further rotatably driving the drive wheel with at least one of the radially inward and outward movement of said at least one crank end; and
a clutch system coupled between the crank system and the drive wheel for allowing the auxiliary transmission system to rotatably drive the drive wheel with the at least one of the radially inward and outward movement of said at least one crank end.

13. A method of rotatably driving a drive sprocket about a drive axis comprising:
providing a pedal system including at least one pedal;
rotatably driving a drive sprocket about a drive axis with rotation of the at least one pedal about the drive axis, the drive sprocket also being capable of rotating relative to the pedal system in one direction;
allowing movement of said at least one pedal radially inward and outward relative to the drive axis; and
further rotatably driving the drive sprocket with at least one of the radially inward and outward movement of said at least one pedal with an auxiliary transmission system coupled between the pedal system and the drive sprocket, a clutch system coupled between the pedal system and the drive sprocket allowing the auxiliary transmission system to rotatably drive the drive sprocket with at least one of the radially inward and outward movement of said at least one pedal.

14. The method of claim 13 further comprising rotatably driving the drive sprocket ahead of the rotation provided by the rotation of the at least one pedal about the drive axis with the auxiliary transmission system.

15. The method of claim 14 further comprising coupling the pedal system to a drive axis shaft.

16. The method of claim 15 further comprising concentrically positioning the drive sprocket about the drive axis shaft.

17. The method of claim 16 in which the pedal system includes first and second pedal assemblies having respective first and second pedals, the method further comprising coupling the first and second pedal assemblies together along the drive axis with the drive axis shaft.

18. The method of claim 17 in which the auxiliary transmission system includes first and second auxiliary transmission assemblies, the method further comprising coupling the first and second transmission assemblies between respective first and second pedal assemblies and the drive sprocket.

19. The method of claim 18 in which the clutch system includes first and second clutch assemblies, the method further comprising coupling the first and second clutch assembly to respective first and second transmission assemblies.

20. The method of claim 19 further comprising providing each pedal assembly with a pivoting linkage which allows the radially inward and outward movement of the pedal.

21. The method of claim 20 in which each auxiliary transmission assembly includes a pinion assembly and a transmission wheel, the transmission wheel and the drive sprocket being configured to rotate in unison about the drive axis, the method further comprising rotating the pinion assembly with one of the radially inward and outward movement of a respective pedal, rotation of the pinion assembly driving the transmission wheel and the drive sprocket

22. The method of claim 20 further comprising providing the auxiliary transmission system with first and second offset wheels rotatably positioned on a parallel axis to the drive axis, the first offset wheel for engaging a first transmission wheel rotatably fixed to the drive sprocket, and the second offset wheel for engaging a second transmission wheel which is rotatably independent from the drive sprocket about the drive axis.

23. The method of claim 13 in which the drive sprocket is on a bicycle, the method further comprising rotatably driving a wheel on the bicycle with a chain engaged with the drive sprocket and the wheel.

24. A method of rotatably driving a drive wheel about a drive axis comprising:
providing a crank system including at least one crank end;
rotatably driving the drive wheel with rotation of the at least one crank end about the drive axis, the drive wheel also being capable of rotating relative to the crank system in one direction;
allowing movement of said at least one crank end radially inward and outward relative to the drive axis; and
further rotatably driving the drive wheel with at least one of the radially inward and outward movement of said at least one crank end with an auxiliary transmission system coupled between the crank system and the drive wheel, a clutch system coupled between the pedal system and the drive wheel allowing the auxiliary transmission system to rotatably drive the drive wheel with at least one of the radially inward and outward movement of said at least one crank end.
